(19) United States
(12) Patent Application Publication
(10) Pub. No.: US 2015/0138133 A1
(43) Pub. Date: May 21, 2015

(54) TOUCHSCREEN DEVICE AND METHOD OF DRIVING THE SAME

(71) Applicant: SAMSUNG ELECTRO-MECHANICS CO., LTD., Suwon (KR)

(72) Inventors: Kang Joo Kim, Suwon (KR); Hyun Jun Kim, Suwon (KR); Byeong Hak Jo, Suwon (KR); Hyun Suk Lee, Suwon (KR); Tah Joon Park, Suwon (KR)

(73) Assignee: SAMSUNG ELECTRO-MECHANICS CO., LTD., Suwon (KR)

(21) Appl. No.: 14/154,952

(22) Filed: Jan. 14, 2014

(30) Foreign Application Priority Data
Nov. 20, 2013 (KR) 10-2013-0141277

(51) Int. Cl. G06F 3/044

(52) U.S. Cl. CPC G06F 3/044
USPC 345/174

(57) ABSTRACT

There are provided a touchscreen device and a method of driving the same. The touchscreen device includes: a driving circuit unit sequentially applying driving signals to a plurality of first electrodes in a plurality of periods of time; a sensing circuit unit acquiring sensing signals from a plurality of second electrodes intersecting with the plurality of first electrodes; a signal conversion unit converting the sensing signals into digital signals; and a buffer unit receiving the sensing signals from the sensing circuit unit and holding the received sensing signals for a predetermined period of time to transmit them to the signal conversion unit, wherein the signal conversion unit converts, during a current period of time among the plurality of periods of time, each of the sensing signals which has been generated according to a driving signal applied during an immediately previous period of time into digital signals.

### CROSS-REFERENCE TO RELATED APPLICATION

This application claims the benefit of Korean Patent Application No. 10-2013-0141277 filed on Nov. 20, 2013, with the Korean Intellectual Property Office, the disclosure of which is incorporated herein by reference.

### BACKGROUND

The present disclosure relates to a touchscreen device and a method of driving the same.

A touch sensing device such as a touchscreen or a touch pad is attached to a display device to provide an intuitive method of data input to a user, and has recently been widely used in various electronic devices such as cellular phones, personal digital assistants (PDA) and navigation devices. In particular, as demand for smartphones has recently increased, touchscreens are being used more and more frequently as touch sensing devices able to provide various methods of data input in a limited form factor.

Touchscreens used in portable devices may be mainly divided into resistive type touchscreens and capacitive type touchscreens, depending on the way in which touches are sensed. Of these types of touchscreen, capacitive type touchscreens have advantages of a relatively long lifespan and ease of implementation of various data input methods utilizing various gestures, and have thus been increasingly employed. A multi-touch interface is especially easy to implement in capacitive type touchscreens, compared to the resistive type touchscreen, and thus capacitive type touchscreens are widely used in smartphones and the like.

Capacitive type touchscreens include a plurality of electrodes having a predetermined pattern where the electrodes sense changes in capacitance are generated due to touches. The nodes deployed on a two-dimensional plane generate a change in self-capacitance or mutual-capacitance due to a touch. Coordinates of the touch may be calculated by applying a weighted average method or the like to the changes in capacitance generated in the nodes.

There is a trend toward a larger touchscreens. In such cases, as touchscreens become larger, the amount of electrodes required therein is increased, such that the response characteristics of the touchscreen may be deteriorated.

### RELATED ART DOCUMENT

(Patent Document 1) Korean Patent Publication No. 10-1056627

### SUMMARY

An aspect of the present disclosure may provide a touchscreen device and a method of driving the same in which a sensing signal generated according to a driving signal applied during an immediately previous period of time may be converted into digital signals during a current period of time.

According to an aspect of the present disclosure, a touchscreen device may include: a driving circuit unit sequentially applying driving signals to a plurality of first electrodes in a plurality of periods of time; a sensing circuit unit acquiring sensing signals from a plurality of second electrodes intersecting with the plurality of first electrodes; a signal conversion unit converting the sensing signals into digital signals; and a buffer unit receiving the sensing signals from the sensing circuit unit and holding the received sensing signals for a predetermined period of time to transmit them to the signal conversion unit, wherein the signal conversion unit converts, during a current period of time among the plurality of periods of time, each of the sensing signals which has been generated according to a driving signal applied during an immediately previous period of time into digital signals.

The sensing circuit unit may include a plurality of C-V converters, wherein each of the C-V converters is connected to the respective second electrodes and acquires the respective sensing signals simultaneously.

The buffer unit may include a plurality of sample-and-hold circuits, wherein respective sample-and-hold circuits among the plurality of sample-and-hold circuits are connected to the respective C-V converters, and wherein the plurality of sample-and-hold circuits transmit the sensing signals simultaneously acquired from the plurality of C-V converters to the signal conversion unit sequentially.

Each of the plurality of C-V converters may convert changes in capacitance generated in intersections between the plurality of first electrodes and the plurality of second electrodes into voltage signals so as to output the voltage signals.

Each of the plurality of C-V converters may include an integration circuit integrating the changes in capacitance to convert them into the voltage signals.

Each of the plurality of sample-and-hold circuits may include: a first switch having one terminal thereof connected to one of the plurality of C-V converters; a capacitor having one terminal thereof connected to the other terminal of the first switch, and the other terminal thereof grounded; and a second switch having one terminal thereof connected to a connection node between the capacitor and the first switch, and the other terminal thereof connected to the signal conversion unit.

Each of the plurality of sample-and-hold circuits may include: a first switch having a terminal thereof connected to one of the plurality of C-V converters; a capacitor having one terminal thereof connected to the other terminal of the first switch, and the other terminal thereof grounded; an operational amplifier having a non-inverting input connected to a connection node between the capacitor and the first switch; a first resistor connected between an inverting input of the operational amplifier and ground; a second resistor connected between an output of the operational amplifier and a connection node between the inverting input of the operational amplifier and the first resistor; and a second switch connected between the signal conversion unit and a connection node between the output of the operational amplifier and the second resistor.

The touchscreen device may further include: a panel unit including the plurality of first electrodes and the plurality of second electrodes.

At least one of the amount of touches, coordinates of the touches, and the types of gesture made during the touches may be determined based on the digital signals.

The periods of time may be consecutive to one another.

The signal conversion unit may start, at the start point of the current period of time, the digital conversion on one of the sensing signals generated according to the driving signal applied during the immediately previous period of time.

The signal conversion unit may consecutively convert the sensing signals generated according to the driving signals applied during the immediately previous period of time into digital signals.

According to another aspect of the present disclosure, a method of driving a touchscreen device may include: sequentially applying driving signals to a plurality of first electrodes in a plurality of periods of time; acquiring sensing signals from a plurality of second electrodes intersecting with the plurality of first electrodes; and converting, during a current period of time among the plurality of periods of time, each of the sensing signals which has been generated according to a driving signal applied during an immediately previous period of time into digital signals.

The periods of time may be consecutive to one another.

The converting may include starting, at the start point of the current period of time, the digital conversion on one of the sensing signals generated according to the driving signal applied during the immediately previous period of time.

The signal conversion unit may consecutively convert the sensing signals generated according to the driving signals applied during the immediately previous period of time into digital signals.

The method may further include, before the converting, holding the sensing signals for different predetermined delay times according to the different sensing signals.

The acquiring may include converting changes in capacitance generated in intersections between the plurality of first electrodes and the plurality of second electrodes into voltage signals.

The method may further include: determining at least one of the amount of touches, coordinates of the touches, and the types of gesture made during the touches based on the digital signals.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view illustrating an appearance of an electronic device including a touchscreen device according to an exemplary embodiment of the present disclosure;

FIG. 2 is a view of a panel unit included in a touchscreen device according to an exemplary embodiment of the present disclosure;

FIG. 3 is a cross-sectional view of a panel unit included in a touchscreen device according to an exemplary embodiment of the present disclosure;

FIG. 4 is a diagram illustrating a touchscreen device according to an exemplary embodiment of the present disclosure;

FIG. 5 is a graph illustrating a driving signal according to an exemplary embodiment of the present disclosure;

FIG. 6 is a graph illustrating a sensing signal according to a driving signal according to an exemplary embodiment of the present disclosure;

FIGS. 7 and 8 are circuit diagrams illustrating sample-and-hold circuits according to exemplary embodiments of the present disclosure in detail; and

FIG. 9 is a graph for illustrating a signal conversion section by a signal conversion unit according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

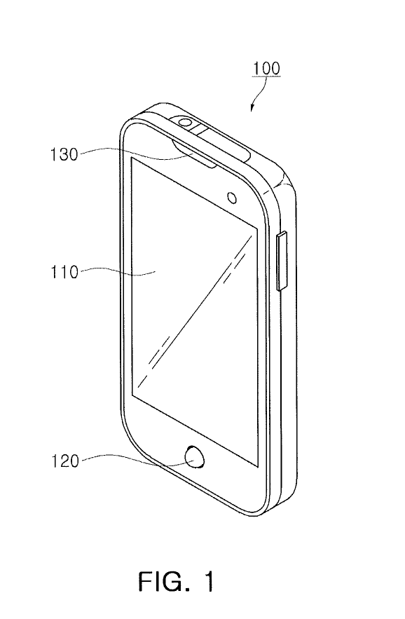

FIG. 1 is a perspective view illustrating an appearance of an electronic device including a touchscreen device according to an exemplary embodiment of the present disclosure.

As shown in FIG. 1, it is common in mobile devices that a touchscreen device is integrated with a display device, and such a touchscreen device needs to have so high light transmittance that a screen displayed on the display device can be seen. Therefore, the touchscreen device may be implemented by forming a sensing electrode using a transparent and electrically conductive material such as indium tin oxide (ITO), indium zinc oxide (IZO), zinc oxide (ZnO), carbon nano tube (CNT), or graphene on a base substrate formed of a transparent film material such as polyethylene terephthalate (PET), polycarbonate (PC), polyethersulfone (PES), polyimide (PI), polymethylmethacrylate (PMMA), or the like. The display device may include a wiring pattern disposed in a bezel region thereof, in which the wiring pattern is connected to the sensing electrode formed of the transparent and conductive material. Since the wiring pattern is hidden by the bezel region, it may be formed of a metal such as silver (Ag) and copper (Cu).

Since the touchscreen device according to the exemplary embodiment is of a capacitive type, the touchscreen device may include a plurality of electrodes having a predetermined pattern. Further, the touchscreen device may include a capacitance sensing circuit to sense a change in the capacitance generated in the plurality of electrodes, an analog-digital conversion circuit to convert an output signal from the capacitance sensing circuit into a digital value, and an operation circuit to determine whether a touch has been made using the data converted into digital value.

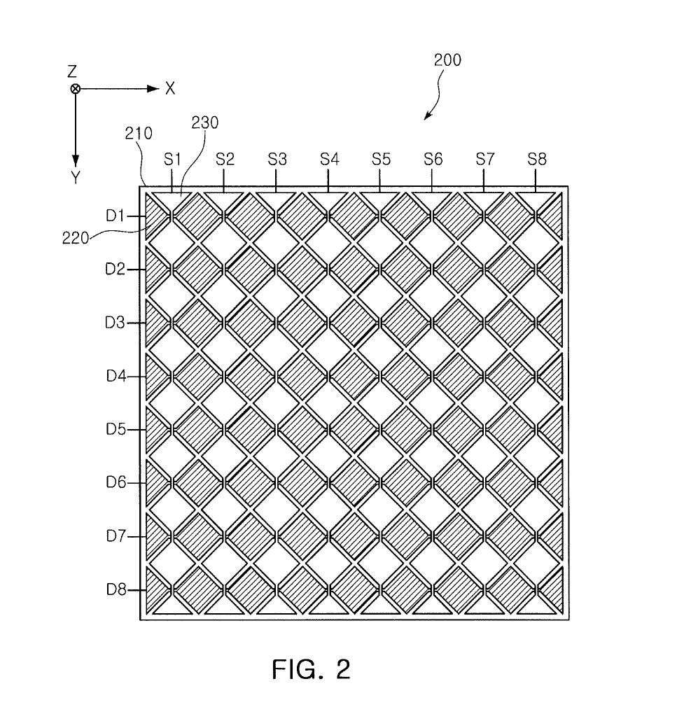

FIG. 2 is a view of a panel unit included in a touchscreen device according to an exemplary embodiment of the present disclosure.

Referring to FIG. 2, the panel unit 200 according to the exemplary embodiment includes a substrate 210 and a plurality of electrodes 220 and 230 provided on the substrate 210. Although not shown in FIG. 2, each of the plurality of electrodes 220 and 230 may be electrically connected to a wiring pattern on a circuit board attached to one end of the substrate 210 through wiring and a bonding pad. The circuit board may have a controller integrated circuit mounted thereon so as to detect sensing signals generated in the plurality of electrodes 220 and 230 and may determine whether a touch has been made based on the detected sensing signals.

The plurality of electrodes 220 and 230 may be formed on one surface or both surfaces of the substrate 210. Although the plurality of electrodes 220 and 230 are shown to have a lozenge- or diamond-shaped pattern in FIG. 2, it is apparent that the plurality of electrodes 220 and 230 may have a variety of polygonal shapes such as rectangular and triangular shapes.

The plurality of electrodes 220 and 230 may include first electrodes 220 extending in the x-axis direction, and second electrodes 230 extending in the y-axis direction. The first electrodes 220 and the second electrodes 230 may be provided on both surfaces of the substrate 210 or may be provided on different substrates 210 such that they may intersect with each other. If all of the first electrodes 220 and the second electrodes 230 are provided on one surface of the substrate 210, an insulating layer may be partially formed at intersection points between the first electrodes 220 and the second electrodes 230. In the regions of the substrate 210 in which wiring connecting to the plurality of electrodes 220 and 230 is provided, other than the region thereof in which the plurality of electrodes 220 and 230 are formed, a printed region may be formed so as to hide the wiring typically formed of an opaque metal.

A device, electrically connected to the plurality of electrodes 220 and 230 to sense a touch, detects a change in capacitance generated in the plurality of electrodes 220 and 230 by a touch to sense the touch based on the detected change in capacitance. The first electrodes 220 may be connected to channels defined as D1 to D8 in the controller integrated circuit to receive predetermined driving signals, and the second electrodes 230 may be connected to channels defined as S1 to S8 to be used by the touchscreen device to detect a sensing signal.

Here, the controller integrated circuit may detect a change in mutual-capacitance generated between the first and second electrodes 220 and 230 as the sensing signal, in a such manner that the driving signals are sequentially applied to the first electrodes 220 and a change in the capacitance is simultaneously detected from the second electrodes 230.

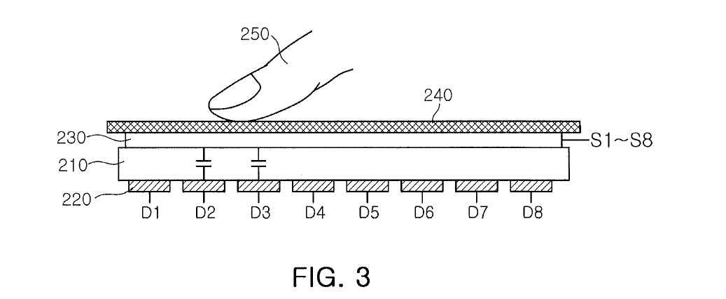

FIG. 3 is a cross-sectional view of a panel unit included in a touchscreen device according to an exemplary embodiment of the present disclosure. FIG. 3 is a cross-sectional view of the panel unit 200 illustrated in FIG. 2 taken in the y-z plane, in which the panel unit 200 may further include a cover lens 240 that is touched, in addition to the substrate 210 and the plurality of sensing electrodes 220 and 230 described above. The cover lens 240 is provided on the second electrodes 230 used in detecting sensing signals, to receive a touch from a touching object 250 such as a finger.

When driving signals are sequentially applied to the first electrodes 220 though the channels D1 to D8, mutual-capacitance is generated between the first electrodes 220, to which the driving signals are applied, and the second electrodes 230. When the driving signals are sequentially applied to the first electrodes 220, a change has been made in mutual-capacitance generated between the first electrode 220 and the second electrodes 230 around the area with which the touching object 250 comes in contact. The change in mutual-capacitance may be proportional to the area of the region on which the first electrodes 220, which the touching object 250 comes into contact with and the driving signals are applied to, and the second electrodes 230 overlap. In FIG. 3, mutual-capacitance generated between the first electrodes 220 connected to channel D2 and D3, respectively, and the second electrodes 230 is influenced by the touching object 250.

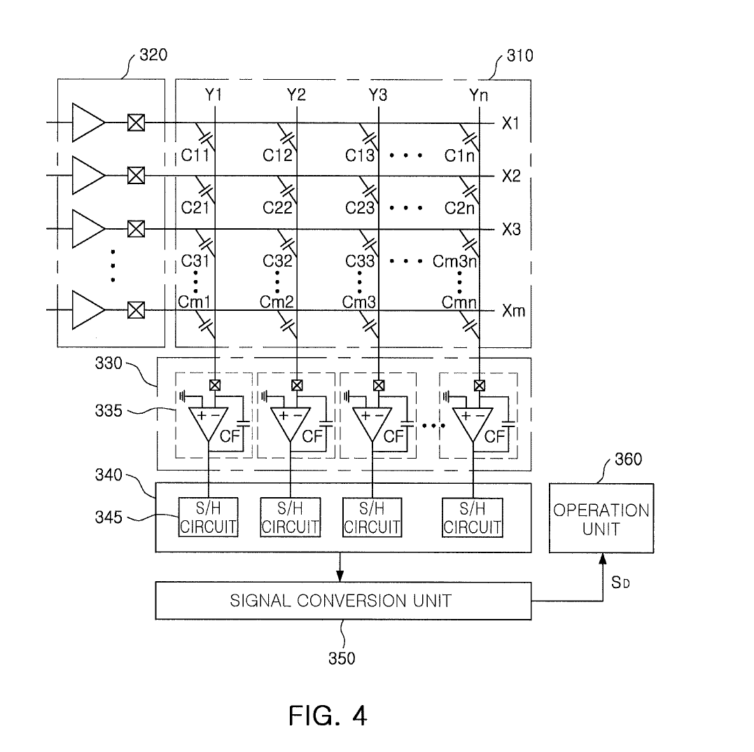

FIG. 4 is a diagram illustrating a touchscreen device according to an exemplary embodiment of the present disclosure. Referring to FIG. 4, the touchscreen device according to the exemplary embodiment may include a panel unit 310, a driving circuit unit 320, a sensing circuit unit 330, a buffer unit 340, a signal conversion unit 350, and an operation unit 360.

The panel unit 310 may include rows of first electrode X1 to Xm extending in a first axis direction (that is, the horizontal direction of FIG. 4), and columns of second electrodes Y1 to Yn extending in a second axis direction (that is, the vertical direction of FIG. 4) crossing the first axis direction. Node capacitors C11 to Cmn are the equivalent representation of mutual capacitance generated in intersections of the first electrodes X1 to Xm and the second electrodes Y1 to Yn. The driving circuit unit 320, the sensing circuit unit 330, the signal converting unit 350, and the calculating unit 360 may be implemented as a single integrated circuit (IC).

The driving circuit unit 320 may apply predetermined driving signals to the first electrodes X1 to Xm of the panel unit 310. The driving signals may be square wave signals, sine wave signals, triangle wave signals or the like having a specific frequency and an amplitude and may be sequentially applied to the plurality of first electrodes. Although FIG. 4 illustrates that circuits for generating and applying the driving signals are individually connected to the plurality of first electrodes X1 to Xm, it is apparent that a single driving signal generating circuit may be used to apply the driving signals to the plurality of first electrodes by employing a switching circuit.

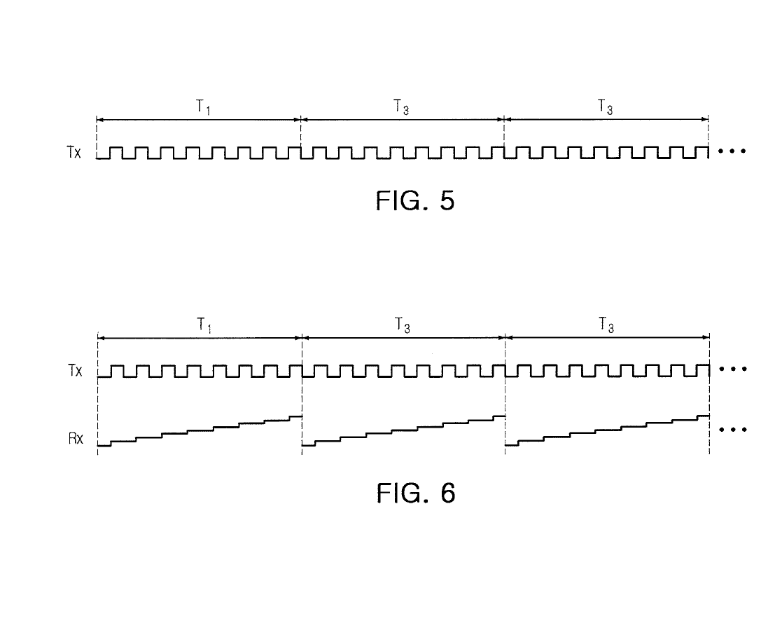

FIG. 5 is a graph illustrating a driving signal according to an exemplary embodiment of the present disclosure. Let us assume that a driving signal Tx is applied to the first electrode X1 of the first electrodes in a period of time T1, and the driving signal Tx is applied to the second electrode X2 of the first electrodes in a period of time T2. According to the exemplary embodiment, the driving circuit unit 320 may apply the driving signal Tx to the plurality of first electrodes X1 to Xm consecutively, without time delay.

Referring to FIG. 4, the sensing circuit unit 330 may detect a change in capacitance of node capacitors C11 to Cmn from the plurality of second electrodes Y1 to Yn to acquire a sensing signal. The sensing circuit unit 330 may include a plurality of C-V converters 335, each of which has at least one operation amplifier and at least one capacitor. The plurality of C-V converters 335 may convert a change in capacitance of the node capacitors C11 to Cmn into a voltage so as to output it. For example, each of the plurality of C-V converters 335 may include an integration circuit for integrating a change in capacitance to convert the change in capacitance into a voltage.

Although each of the C-V converters 335 shown in FIG. 4 has the configuration in which a capacitor CF is connected between the inverting input and the output of an operation amplifier, it is apparent that the circuit configuration may be altered. Moreover, each of the C-V converters 335 shown in FIG. 4 has one operational amplifier and one capacitor, it may have a number of operational amplifiers and capacitors to convert a change in capacitance into a voltage and output the voltage.

When driving signals are applied to the first electrodes X1 to Xm sequentially, a change in capacitance of the capacitors C11 to Cmn may be detected simultaneously from the second electrodes, the amount of required C-V converts 335 is equal to the amount of the second electrodes Y1 to Yn, i.e., n.

FIG. 6 is a graph illustrating a sensing signal according to a driving signal according to an exemplary embodiment of the present disclosure.

When the driving circuit unit 320 applies a driving signal Tx having a specific period to the plurality of first electrodes, the sensing circuit unit 330 may be connected to the second electrodes to generate a sensing signal Rx that is incremented at each predetermined period. During the period in which a driving signal is applied, the sensing circuit unit 330 may convert the change in capacitance generated in the node capacitors into a voltage signal and may acquire a sensing signal when the applied driving signal ends, i.e., at the end point of T1.

Referring back to FIG. 4, the buffer unit 340 may include a plurality of sample-and-hold circuits 345, each of which is connected to respective C-V converters among the plurality of the C-V converters 335. The plurality of sample-and-hold circuits 345 may delay an analog sensing signal output from the plurality of C-V converters 335 to transmit it to the signal conversion unit 350.

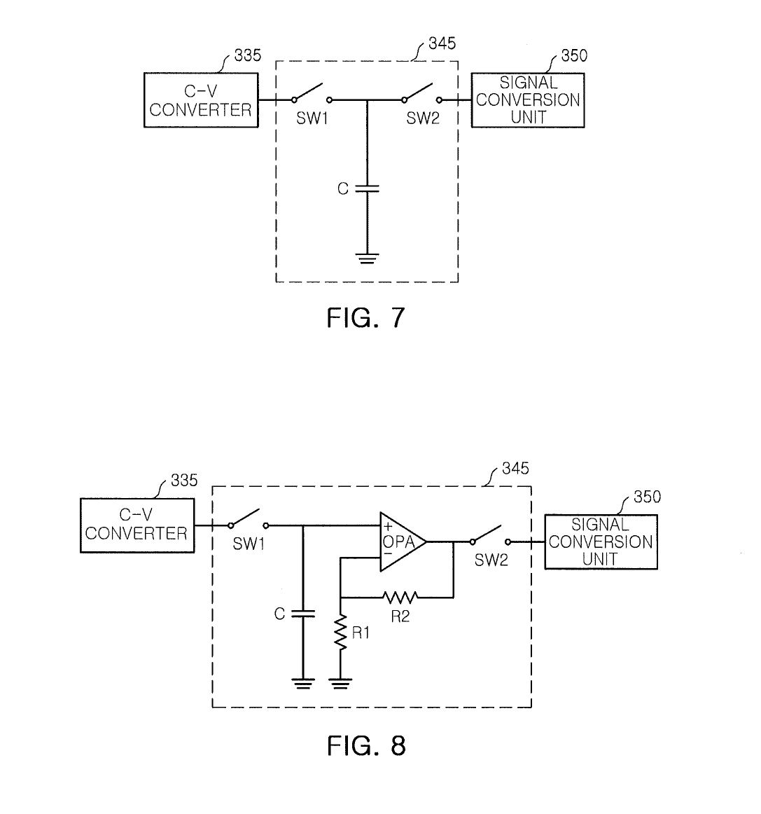

FIGS. 7 and 8 are circuit diagrams illustrating sample-and-hold circuits according to exemplary embodiments of the present disclosure in detail. Referring to FIG. 7, a sample-and-hold circuit 345 may include a switch SW1, a capacitor C, a switch SW2, and, referring to FIG. 8, may further include resistors R1 and R2, and an operational amplifier OPA.

Referring to FIG. 7, the switch SW1 may have one terminal thereof connected to the C-V converter 335 and the other terminal thereof connected to a terminal of a capacitor C, and the switch SW2 may have one terminal thereof connected to the terminal of the capacitor C and the other terminal thereof connected to the signal conversion unit 350. In addition, the other terminal of the capacitor C may be grounded.

Further, referring to FIG. 8, the switch SW1 may have one terminal thereof connected to the C-V converter 335 and the other terminal thereof connected to one terminal of a capacitor C, and the other terminal of the capacitor C may be grounded. The terminal of the capacitor C may be connected to a non-inverting input of an operational amplifier OPA, and an inverting input of the operational amplifier OPA may be grounded via a resistor R1. Further, a connection node between the inverting input of the operational amplifier OPA and the resistor R1 may be connected to the output of the operational amplifier OPA via a resistor R2. The connection node between the output of the operational amplifier OPA and the resistor R2 may be connected to the signal conversion unit 350 via the switch SW2.

As shown in FIG. 7, upon the switch SW1 being turned on, a sensing signal in the form of voltage from the C-V converter 335 is stored in the capacitor C, and the switch SW2 is turned on after the switch SW1 is turned off, such that the sensing signal stored in the capacitor C may be transmitted to the signal conversion unit 350.

When the sensing signal is transmitted from the C-V converter 335 to the capacitor C, some of the voltage may be lost. The sample-and-hold circuit shown in FIG. 8 includes an operational amplifier OPA and resistors R1 and R2 so as to compensate for the voltage loss. The voltages at the inverting input and the non-inverting input are equal to each other under a virtual short condition of the operational amplifier OPA, and the voltage loss in the sensing signal may be compensated for according to the ratio between the resistors R1 and R2 connected to the non-inverting input.

When a driving signal is applied to the first electrode X1 of the plurality of first electrodes X1 to Xm, n sensing signals may be acquired from the plurality of second electrodes Y1 to Yn. The plurality of sample-and-hold circuits 345 may transmit the held sensing signals to the signal conversion unit 350 taking time required for analog-digital conversion in the signal conversion unit 350 into account.

For example, if the plurality of sample-and-hold circuits 345 transmit the held sensing signals from the first second electrode Y1 to the nth second electrode Yn of the second electrodes sequentially, the sample-and-hold circuits 345 which hold the sensing signal acquired from the first one Y1 of the second electrodes may transmit it to the signal conversion unit 350 without time delay. Since it takes time for the signal conversion unit 350 to convert the sensing signal acquired from the first one Y1 of the second electrodes into a digital signal, the sample-and-hold circuit 345 which holds the sensing signal acquired from the second one Y2 of the second electrodes may transmit the digital signals when the signal conversion unit 350 completes the digital conversion. By doing so, the signal conversion unit 350 may consecutively convert n sensing signals into digital signals.

The signal conversion unit 350 may receive sensing signals sequentially transmitted from the plurality of sample-and-hold circuits in the buffer unit 340 to generate digital signals S_{D}. For example, the signal converting unit 350 may include a time to digital converter (TDC) circuit measuring a time in which the analog signals in the form of voltage output from the sensing circuit unit 330 reach a predetermined reference voltage level to convert the measured time into the digital signals S_{D}, or an analog to digital converter (ADC) circuit measuring an amount by which a level of the sensing signals in the form of voltage is changed for a predetermined period of time to convert the changed amount into the digital signals S_{D}.

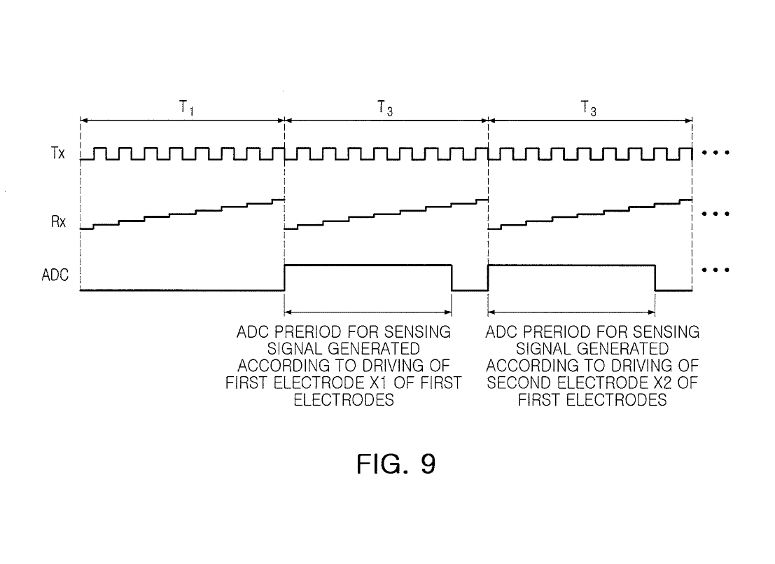

FIG. 9 is a graph for illustrating a signal conversion section by a signal conversion unit according to an exemplary embodiment of the present disclosure.

The signal conversion unit 350 may perform, during the period of time in which the current driving signal is applied, digital conversion on a sensing signal generated according to a driving signal applied during the immediately previous period of time. Specifically, as shown in FIG. 9, the signal conversion unit 350 may start performing digital conversion on the sensing signal generated when the first electrode X1 of the first electrodes is driven at the start time when the second electrode X2 of the first electrodes is driven, i.e., the start point of T2, and may complete the digital conversion before the second electrode X2 of the first electrodes is stopped being driven, i.e., the end point of T2.

The operation unit 360 may determine whether a touch is input on the panel unit 310 using the digital signals S_{D}. The operation unit 360 may determine the amount of touches, coordinates of the touches, and the types of gesture made during the touches or the like on the panel unit 310, based on the digital signals S_{D}.

As set forth above, according to exemplary embodiments of the present disclosure, a sensing signal generated according to a driving signal applied during an immediately previous period of time may be converted into a digital signal during a current period of time, such that the response speed of a touchscreen device may be improved.

While exemplary embodiments have been shown and described above, it will be apparent to those skilled in the art that modifications and variations could be made without departing from the spirit and scope of the present disclosure as defined by the appended claims.

What is claimed is:

1. A touchscreen device, comprising:
a driving circuit unit sequentially applying driving signals to a plurality of first electrodes in a plurality of periods of time;
a sensing circuit unit acquiring sensing signals from a plurality of second electrodes intersecting with the plurality of first electrodes;
a signal conversion unit converting the sensing signals into digital signals; and
a buffer unit receiving the sensing signals from the sensing circuit unit and holding the received sensing signals for a predetermined period of time to transmit them to the signal conversion unit,
wherein the signal conversion unit converts, during a current period of time among the plurality of periods of time, each of the sensing signals which has been generated according to a driving signal applied during an immediately previous period of time into digital signals.

2. The touchscreen device of claim 1, wherein the sensing circuit unit includes a plurality of C-V converters, wherein each of the C-V converters is connected to the respective second electrodes and acquires the respective sensing signals simultaneously.

3. The touchscreen device of claim 2, wherein the buffer unit includes a plurality of sample-and-hold circuits, wherein respective sample-and-hold circuits among the plurality of sample-and-hold circuits are connected to the respective C-V converters, and wherein the plurality of sample-and-hold circuits transmit the sensing signals simultaneously acquired from the plurality of C-V converters to the signal conversion unit sequentially.

4. The touchscreen device of claim 2, wherein each of the plurality of C-V converters converts changes in capacitance generated in intersections between the plurality of first electrodes and the plurality of second electrodes into voltage signals so as to output the voltage signals.

5. The touchscreen device of claim 4, wherein each of the plurality of C-V converters includes an integration circuit integrating the changes in capacitance to convert them into the voltage signals.

6. The touchscreen device of claim 3, wherein each of the plurality of sample-and-hold circuits includes:
a first switch having a terminal thereof connected to one of the plurality of C-V converters;
a capacitor having one terminal thereof connected to the other terminal of the first switch, and the other terminal thereof grounded; and
a second switch having one terminal thereof connected to a connection node between the capacitor and the first switch, and the other terminal thereof connected to the signal conversion unit.

7. The touchscreen device of claim 3, wherein each of the plurality of sample-and-hold circuits includes:
a first switch having a terminal thereof connected to one of the plurality of C-V converters;
a capacitor having one terminal thereof connected to the other terminal of the first switch, and the other terminal thereof grounded;
an operational amplifier having a non-inverting input connected to a connection node between the capacitor and the first switch;
a first resistor connected between an inverting input of the operational amplifier and ground;
a second resistor connected between an output of the operational amplifier and a connection node between the inverting input of the operational amplifier and the first resistor; and
a second switch connected between the signal conversion unit and a connection node between the output of the operational amplifier and the second resistor.

8. The touchscreen device of claim 1, further comprising:
a panel unit including the plurality of first electrodes and the plurality of second electrodes.

9. The touchscreen device of claim 1, wherein at least one of the amount of touches, coordinates of the touches, and the types of gesture made during the touches is determined based on the digital signals.

10. The touchscreen device of claim 1, wherein the periods of time are consecutive to one another.

11. The touchscreen device of claim 1, wherein the signal conversion unit starts, at the start point of the current period of time, the digital conversion on one of the sensing signals generated according to the driving signal applied during the immediately previous period of time.

12. The touchscreen device of claim 11, wherein the signal conversion unit consecutively converts the sensing signals generated according to the driving signals applied during the immediately previous period of time into digital signals.

13. A method of driving a touchscreen device, the method comprising:
sequentially applying driving signals to a plurality of first electrodes in a plurality of periods of time;
acquiring sensing signals from a plurality of second electrodes intersecting with the plurality of first electrodes; and
converting, during a current period of time among the plurality of periods of time, each of the sensing signals which has been generated according to a driving signal applied during an immediately previous period of time into digital signals.

14. The method of claim 13, wherein the periods of time are consecutive to one another.

15. The method of claim 13, wherein the converting includes starting, at the start point of the current period of time, the digital conversion on one of the sensing signals generated according to the driving signal applied during the immediately previous period of time.

16. The method of claim 13, wherein the signal conversion unit consecutively converts into digital signal the sensing signals generated according to the driving signals applied during the immediately previous period of time.

17. The method of claim 13, further comprising:
before the converting, holding the sensing signals for different predetermined delay times according to the different sensing signals.

18. The method of claim 13, wherein the acquiring includes converting changes in capacitance generated in intersections between the plurality of first electrodes and the plurality of second electrodes into voltage signals.

19. The method of claim 13, further comprising: determining at least one of the amount of touches, coordinates of the touches, and the types of gesture made during the touches based on the digital signals.
